(19) United States
(12) Patent Application Publication
(10) Pub. No.: US 2009/0323578 A1
(43) Pub. Date: Dec. 31, 2009

(54) Wireless Vehicle Communication Method Utilizing Wired Backbone

(75) Inventors: Thomas Alfons Hogenmueller, Sunnyvale, CA (US); Vivek Jain, Mountain View, CA (US)

Correspondence Address: TAFT STETTINIUS & HOLLISTER LLP, ONE INDIANA SQUARE, SUITE 3500, INDIANAPOLIS, IN, 46204, US

(73) Assignee: Robert Bosch GmbH, Stuttgart, DE (US)

(21) Appl. No.: 12/145,989

(22) Filed: Jun. 25, 2008

(51) Int. Cl. H04B 7/14; H04L 12/56

(52) U.S. Cl. 370/315; 370/401

(57) ABSTRACT

A method for providing electronic communications between nodes of a vehicle includes electronically connecting a plurality of gateway nodes to one another via a wired backbone. A first and second of the gateway nodes are electronically connected to the wired backbone. A plurality of sub-network nodes are wirelessly communicatively coupled to each of the plurality of gateway nodes. A plurality of first sub-network nodes are wirelessly communicatively coupled to the first gateway node. A plurality of second sub-network nodes are wirelessly communicatively coupled to the second gateway node. A message is transmitted from a selected first sub-network node to a selected second sub-network node by using a data routing technique. The data routing technique includes the selected first sub-network node wirelessly transmitting the message to the first gateway node. The first gateway node receives the message and, in response thereto, the first gateway node broadcasts the message on the wired backbone. The second gateway node receives the message on the wired backbone and, in response thereto, the second gateway node wirelessly transmits the message to the selected second sub-network node.

### BACKGROUND

1. Field of the Invention

The present invention relates to a method for wireless communication, and, more particularly, to a method for wireless communication with increased performance and reliability within a vehicle.

2. Description of the Related Art

It is known for wireless communication to be employed between and within various systems within a vehicle, such as an automobile. Attaining reliable wireless communication with good performance is problematic within a vehicle, however, because wireless communication is deeply affected by fading due to multipath, and human and metallic obstructions inside the vehicle. Hence, researchers have proposed to use multihop communication to communicate between pairs of wireless gateways/nodes that are separated by a distance of a few meters or less. However, poorly designed multihop systems can lead only to greater delays due to bottleneck relay nodes and unreliable individual links.

The state-of-the-art of automotive electronics is progressing rapidly and it is projected that electronics alone will make up forty percent of the total cost of future cars. All these electronic units in the vehicle are connected through different bus systems depending on the application requirements. Typically, an automotive network 100 (FIG. 1) consists of several sub-networks, such as sub-networks 112, 114, connected together to form a larger network, sub-networks technology being used are for instance the Local Interconnect Network (LIN). Each sub-network consists of a gateway node 116 and some sensor/actuator nodes 118. Network 100 may include a wired backbone 120 compatible with a Controller Area Network (CAN), FlexRay, Ethernet, etc. Network 100 may also include a body computer 124 and wired communication links 122 compatible with a CAN, Local Interconnect Network (LIN), FlexRay, Ethernet, etc.

There have been recent proposals to make automotive sub-networks wireless, as are sub-networks 212, 214 of network 200 shown in FIG. 2. However, it is important to note that these sub-networks are not totally independent and need to communicate with a central body computer 224, other wired nodes like 246 or amongst each other for data communication and/or diagnostic purposes.

Wireless channels inside vehicles are severely affected by fading due to multipath as well as human and metallic obstructions. In order to mitigate the fading effects, power control and multihop solutions have been proposed. However, if not designed properly, a multihop solution may have several possible problems. First, in many scenarios, even multihop solutions cannot provide a required level of reliability when individual single hop links are not good. Second, a multihop solution can lead to a longer delay in overall data communication. Assuming that it takes t seconds to transmit data over a single hop, then a k-hop solution will take at least k×t seconds to transmit data from one end node to another. Third, the intermediate relay nodes can easily become the bottleneck in the network. Fourth, the wireless channel is more occupied by wireless transmissions and cannot be used for simultaneous transmissions.

Power control, on the other hand, has its own disadvantages as power cannot be increased indefinitely to improve the probability of successful transmission. There is an upper limit on the level of transmitted power. Also, if the nodes are battery operated, the greater the transmission power, the higher the energy consumption, which may severely affect the duration of the node lifetime.

What is needed in the art is a method for wireless network communication that avoids the above-mentioned problems and disadvantages.

### SUMMARY OF THE INVENTION

The present invention provides a method for wireless network communication with increased performance by use of existing in-vehicle wired networks as the network's backbone. Examples of such existing in-vehicle wired networks include a CAN, FlexRay and Ethernet.

The present invention provides two data routing techniques, namely simple flooding and selective multicast for use with the proposed architecture. The present invention further incorporates frequency diversity for different sub-networks so that they can operate concurrently, thereby improving the system response time.

The present invention's use of a wired backbone, data routing techniques and frequency diversity may be applicable for automotive networks as well as for other applications. For example, the principles of the present invention may be applied to industrial networks, cargo, airplanes ships, etc.

The invention comprises, in one form thereof, a method for providing electronic communications between nodes of a vehicle, including electronically connecting a plurality of gateway nodes to one another via a wired backbone. A first and second of the gateway nodes are electronically connected to the wired backbone. A plurality of sub-network nodes are wirelessly communicatively coupled to each of the plurality of gateway nodes. A plurality of first sub-network nodes are wirelessly communicatively coupled to the first gateway node. A plurality of second sub-network nodes are wirelessly communicatively coupled to the second gateway node. A message is transmitted from a selected first sub-network node to a selected second sub-network node by using a data routing technique. The data routing technique includes the selected first sub-network node wirelessly transmitting the message to the first gateway node. The first gateway node receives the message and, in response thereto, the first gateway node broadcasts the message on the wired backbone. The second gateway node receives the message on the wired backbone and, in response thereto, the second gateway node wirelessly transmits the message to the selected second sub-network node.

The invention comprises, in another form thereof, a method for providing electronic communications between nodes of a vehicle, including electronically connecting a plurality of gateway nodes to one another via a wired backbone. A first and second of the gateway nodes are electronically connected to the wired backbone. A plurality of sub-network nodes are wirelessly communicatively coupled to respective ones of the plurality of gateway nodes. A plurality of first sub-network nodes are wirelessly communicatively coupled to the first gateway node. A plurality of second sub-network nodes are wirelessly communicatively coupled to the second gateway node. A message including a distinct identifier is transmitted. The message is transmitted from a selected first sub-network node to a selected second sub-network node by using a selective multicast data routing technique. At least one of the plurality of sub-network nodes is a subscribing node. The at least one subscribing node subscribes to the distinct identifier. The selective multicast data routing technique includes the selected first sub-network node wirelessly transmitting the message to the first gateway node. The first gateway node receives the message and, in response thereto, the first gateway node broadcasts the message on the wired backbone. Each other one of the plurality of gateway nodes receives the message broadcasted on the wired backbone by the first gateway node and, in response thereto, only those of the plurality of gateway nodes that are coupled to at least one of the subscribing nodes broadcast the message to the plurality of sub-network nodes coupled thereto. The selected second sub-network node is a subscribing node.

The invention comprises, in yet another form thereof, a method for providing electronic communications between nodes of a vehicle, including electronically connecting a plurality of gateway nodes to one another via a wired backbone. A first and second of the gateway nodes are electronically connected to the wired backbone. A plurality of sub-network nodes are wirelessly communicatively coupled to each of the plurality of gateway nodes. A plurality of first sub-network nodes are wirelessly communicatively coupled to the first gateway node. A plurality of second sub-network nodes are wirelessly communicatively coupled to the second gateway node. A message is transmitted from a selected first sub-network node to a selected second sub-network node by using a data routing technique. The data routing technique includes the selected first sub-network node wirelessly transmitting the message to the first gateway node using a first frequency. The first gateway node receives the message and, in response thereto, the first gateway node broadcasts the message on the wired backbone. The second gateway node receives the message and, in response thereto, the second gateway node wirelessly transmits the message to the selected second sub-network node using a second frequency different from the first frequency.

An advantage of the present invention is that the wired backbone provides superior communication speed and reliability, and the wireless sub-network nodes provide system flexibility and ease of installation.

Another advantage is that the selective multicast data routing technique conserves battery power of the wireless sub-network nodes.

Another advantage is the possibility to increase the overall network expansion.

Yet another advantage is that the frequency diversity technique may be used to increase efficiency, reduce the probability of interference, and increase system security.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of a wired automotive network of the prior art.

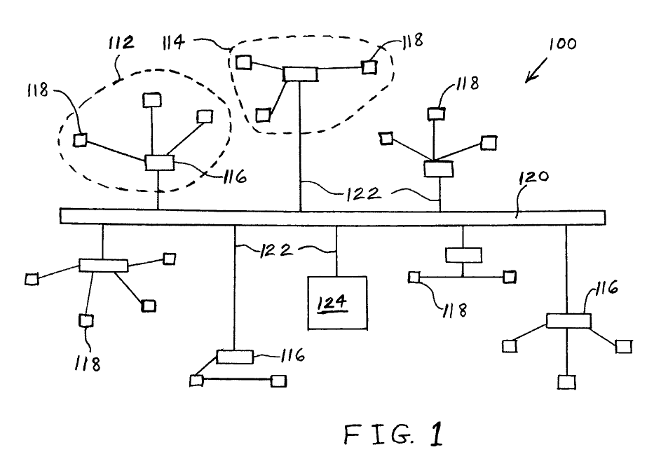

FIG. 2 is a block diagram of an automotive network of the prior art including wired and wireless sub-networks without any common communications backbone.

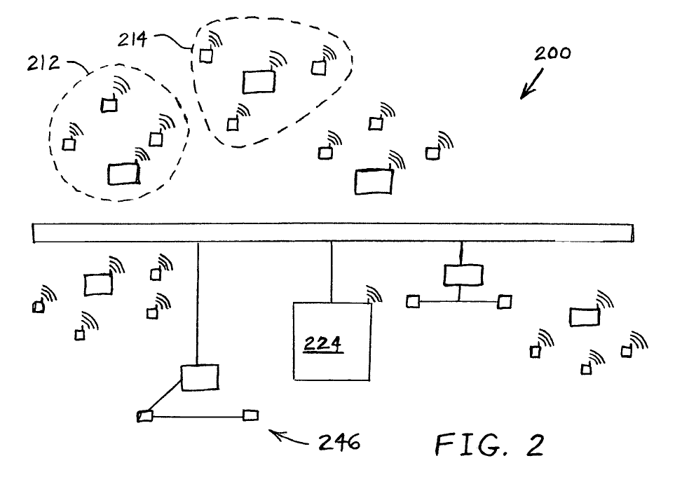

FIG. 3 is a block diagram of one embodiment of an automotive network of the present invention including a common wired backbone for both wired and wireless sub-networks.

FIG. 4 is a block diagram of another embodiment of an automotive network of the present invention incorporating a simple flooding data routing technique.

FIG. 5 is a block diagram of yet another embodiment of an automotive network of the present invention incorporating a selective multicast data routing technique.

FIG. 6 is a flow chart illustrating one embodiment of a method of the present invention for providing electronic communications between nodes of a vehicle.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

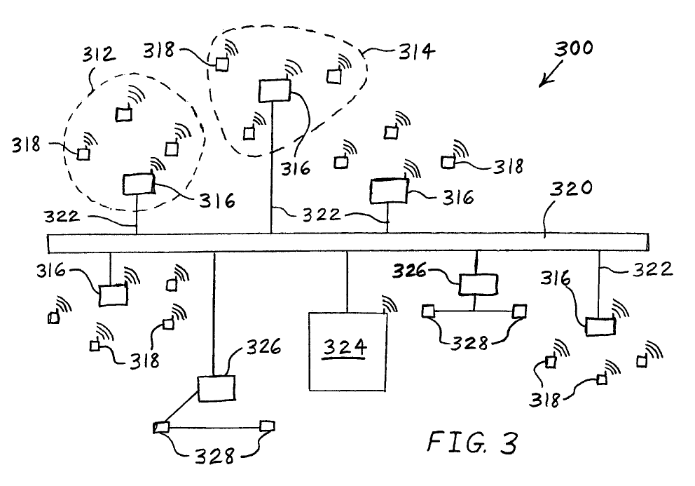

Referring now to FIG. 3, there is shown an automotive network 300 of the present invention which may circumvent the problems of the prior art by using a wired network as a backbone 320 to interconnect a plurality of wireless gateways 316. Wireless gateways 316 may communicate wirelessly, such as via radio frequency communication, with wireless sensor/actuator nodes 318 within the sub-network of each gateway 316. Network 300 may includes wired gateways 326 that are hard wired to sensor/actuator nodes 328 within the sub-network of each gateway 326.

Advantageously, each wireless gateway node 316 may be hard wired via a respective communication link 322 to body computer 324. Thus, the channel between gateway nodes 316 and body computer 324 may be unaffected by fading and may have superior reliability.

Another advantage of the architecture of network 300 is that frequency diversity can be used in conjunction with sub-networks 316 so that they can operate concurrently, thereby reducing the network delay and increasing the system responsiveness. Yet another advantage of network 300 is that the proposed architecture may have lesser delay times due to having channels of greater reliability. A further advantage of network 300 is that integration with other networks within the automobile may be easily accomplished as compared to a completely wireless architecture.

A still further advantage of network 300 is that gateway nodes 316 can also monitor their sub-networks (e.g., sub-networks, 312, 314, etc.) for security intrusion or hostile environments such as temporary jamming of the wireless channel. Thus, this information regarding security intrusion and hostile environments can be reliably transmitted to body computer 324 in a relatively short period of time. Lastly, an advantage of network 300 is that the proposed architecture enjoys the superior reliability of wired connections as well as the flexibility of wireless connections.

Various data routing techniques may be utilized in conjunction with the architectures of the present invention. Generally, broadcasting is the communication method employed in the automotive networks of the present invention. In broadcasting, the transmitter node may broadcast a message on the channel and the nodes that are interested in the message receive it. This may be facilitated by each message having its own distinct identifier and all nodes in the network subscribing to a set of these messages which they transmit or listen to. This type of scheme may be referred to as “message addressing” as nodes are not addressed directly but rather are addressed through the messages. Message addressing has specific benefits in the automotive world as the nodes can be produced in bulk without any need for providing a separate address for each of them. Thus, message addressing may be a feature provided within the present invention for any communication architecture for automotive networks.

The use of distinct identifiers may be possible without a body computer. In this case, the frequency hopping sequence needs to be known by each node within the sub-network.

Within the scope of the present invention, there may be several alternative communication approaches, or “data routing techniques,” using message addressing that are possible in the proposed network. A trivial form of such a communication approach may be referred to as “simple flooding” wherein the role of the gateway node may be to relay messages from its sub-network to the wired backbone and from the wired backbone to its sub-network.

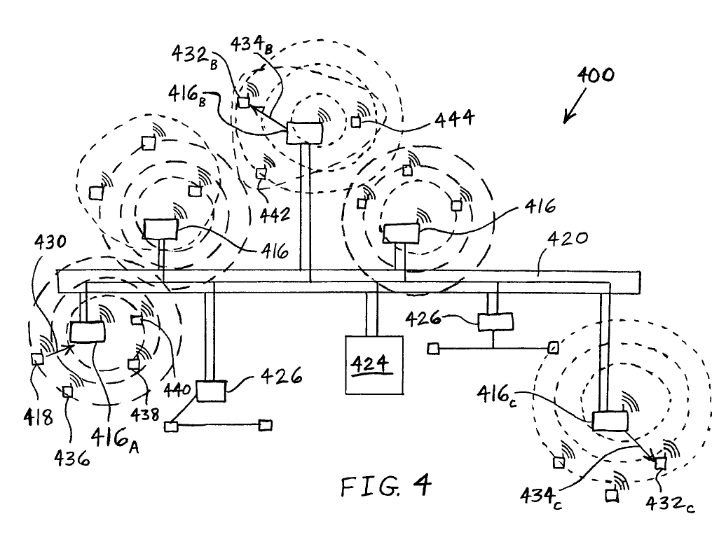

In simple flooding, the communication may occur in steps described below with reference to network 400 of FIG. 4 having a body computer 424. In a first step, a transmitter node 418 transmits a message within its sub-network, as indicated by arrow 430. In a second step, the gateway node 416_{A} of the sub-network receives the message and broadcasts the message on wired backbone 420. In a third step, all gateway nodes receive the message and then retransmit the same message in their respective sub-network. In the specific example of FIG. 4, each of the five wireless gateway nodes 416 as well as each of the two wired gateway nodes 426 receive and retransmit the same message in their respective sub-network. In a fourth step, only receiver nodes 432_{B}, 432_{C} receive the message from respective gateway nodes 416_{B}, 416_{C}, as indicated by arrows 434_{B}, 434_{C}. Receiver nodes 432_{B}, 432_{C} may be the only sensor/actuator nodes that subscribe to the particular type of the message, and thus receiver nodes 432_{B}, 432_{C} may be the only sensor/actuator nodes that receive the message. The type of the message may be indicated by a distinct message type identifier within the message.

Another type of data routing technique may be referred to as “selective multicast” in which each of the gateway nodes may maintain a record of message identifiers each of its sub-network nodes subscribes to. This may have the advantage that the gateway nodes relay only relevant messages, thereby reducing the network traffic. A further possible advantage is that, since the sub-network nodes may be running on battery power, this scheme may avoid the sub-network nodes wasting their energy in receiving messages intended for only other sub-network nodes.

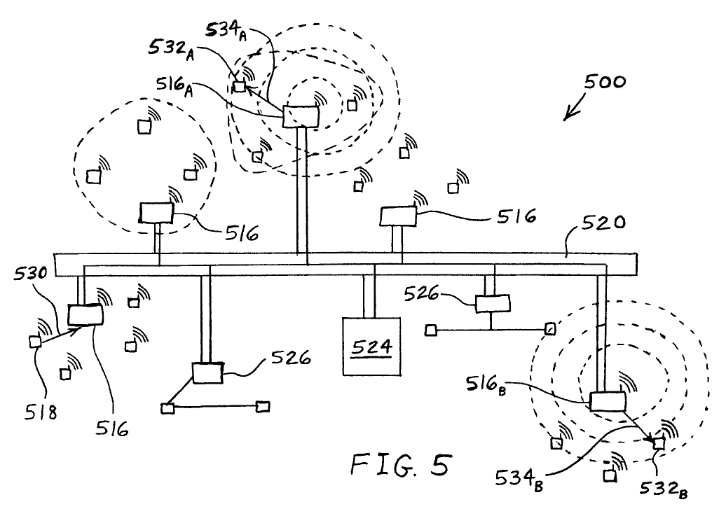

In selective multicast, the communication may occur in steps described below with reference to network 500 of FIG. 5 having a body computer 524. In a first step, a transmitter node 518 transmits a message within its sub-network, as indicated by arrow 530. In a second step, the gateway node 516 of the sub-network receives the message and broadcasts the message on wired backbone 520. In a third step, all gateway nodes receive the message. In the specific example of FIG. 5, each of the five wireless gateway nodes 516 as well as each of the two wired gateway nodes 526 receive the same message. However, in contrast to the simple flooding technique described above, the message is retransmitted by only those gateway nodes that have at least one node subscribing to the message in their respective sub-network. In the specific example of FIG. 5, only gateway nodes 516_{A} and 516_{B} have at least one node (i.e., receiver nodes 532_{A} and 532_{B}, respectively) subscribing to the message in their respective sub-network, and thus only gateway nodes 516_{A} and 516_{B} retransmit the message, as indicated by the concentric dashed circles surrounding gateway nodes 516_{A} and 516_{B} in FIG. 5. In a fourth step, only receiver nodes 532_{A} and 532_{B} receive the message, as indicated by arrows 534_{A} and 534_{B}. Receiver nodes 532_{A} and 532_{B} may be the only sensor/actuator nodes that subscribe to the particular type of the message, and thus receiver nodes 532_{A} and 532_{B} may be the only sensor/actuator nodes that receive the message. The type of the message may be indicated by a distinct message type identifier within the message.

In order to improve network performance, the architecture of the present invention may allow frequency diversity, i.e., using a different operating frequency for each sub-network. Because each sub-network is a separate entity, each sub-network can use a distinct, respective frequency for its operation. Frequency diversity combined with the proposed architecture has numerous advantages. First, each sub-network can operate independently with its own respective schedule instead of having to follow one common network schedule if frequency diversity is not used. Second, using individual, distinct schedules for each sub-network may result in better system response and reduced delay. Third, the body computer can assist the gateway nodes in selecting desirable frequencies for their sub-networks, thereby reducing the need for complex algorithms for frequency selection on each gateway node. Fourth, there is a reduced probability of interference from different sub-networks of the same vehicle or of nearby vehicles. Fifth, frequency hopping techniques can be applied to individual sub-networks which in turn may improve the security and reliability of the wireless sub-network.

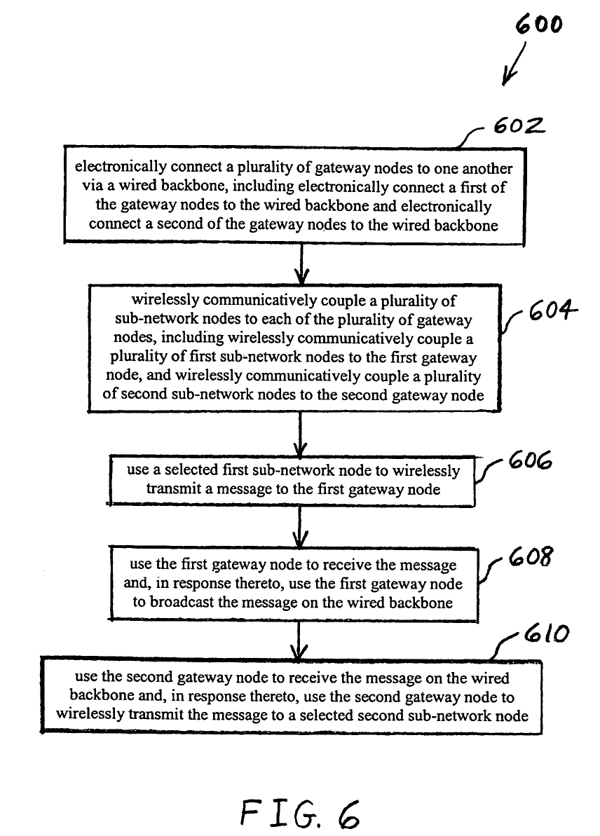

One embodiment of a method 600 of the present invention for providing electronic communications between nodes of a vehicle is illustrated in FIG. 6. In a first step 602, a plurality of gateway nodes are electronically connected to one another via a wired backbone, including electronically connecting a first of the gateway nodes to the wired backbone and electronically connecting a second of the gateway nodes to the wired backbone. For example, in the embodiment illustrated in FIG. 4, a plurality of gateway nodes 416 are electronically connected to one another via wired backbone 420. This electrically connecting step includes electronically connecting a first gateway node 416_{A} to the wired backbone and electronically connecting a second gateway node 416_{B} to wired backbone 420.

In a second step 604, a plurality of sub-network nodes are wirelessly communicatively coupled to each of the plurality of gateway nodes, including wirelessly communicatively coupling a plurality of first sub-network nodes to the first gateway node, and wirelessly communicatively coupling a plurality of second sub-network nodes to the second gateway node. In the embodiment of FIG. 4, sub-network nodes 418, 436, 438, 440 are wirelessly communicatively coupled to gateway node 416_{A}; and sub-network nodes 432_{B}, 442, 444 are wirelessly communicatively coupled to gateway node 416B.

In a third step 606, a selected first sub-network node is used to wirelessly transmit the message to the first gateway node. That is, sub-network node 418 may be used to wirelessly transmit the message to first gateway node 416_{A}, as indicated by arrow 430.

In a fourth step 608, the first gateway node receives the message and, in response thereto, the first gateway node broadcasts the message on the wired backbone. More particularly, gateway node 416_{A} may receive the message and, in response thereto, gateway node 416_{A} may broadcast the message on wired backbone 420.

In a fifth step 610, the second gateway node receives the message on the wired backbone and, in response thereto, the second gateway node wirelessly transmits the message to the selected second sub-network node. In the embodiment of FIG. 4, gateway node 416_{B} receives the message on wired backbone 420 and, in response thereto, gateway node 416_{B} wirelessly transmits the message to the selected second sub-network node 432_{B}, as indicated by arrow 434_{B}.

In the case where frequency diversity is utilized, gateway node 416_{B} wirelessly transmits the message to the selected second sub-network node 432_{B} using a frequency that is different than the frequency used by sub-network node 418 in transmitting the message to gateway node 416_{A}. In general, frequencies to be used may be selected by the body computer. Further, the body computer may periodically select different frequencies on which wireless communication is conducted between the gateway nodes and the sub-network nodes.

It should be noted that although method 600 is described above with reference to FIG. 4, method 600 could alternatively be described with reference to FIG. 5.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for providing electronic communications between nodes of a vehicle, the method comprising the steps of:
electronically connecting a plurality of gateway nodes to one another via a wired backbone, including electronically connecting a first of the gateway nodes to the wired backbone and electronically connecting a second of the gateway nodes to the wired backbone;
wirelessly communicatively coupling a plurality of sub-network nodes to each of the plurality of gateway nodes, including wirelessly communicatively coupling a plurality of first sub-network nodes to the first gateway node, and wirelessly communicatively coupling a plurality of second sub-network nodes to the second gateway node; and
transmitting a message from a selected said first sub-network node to a selected said second sub-network node by using a data routing technique,
wherein the data routing technique includes the steps of the selected first sub-network node wirelessly transmitting the message to the first gateway node; the first gateway node receiving the message and, in response thereto, the first gateway node broadcasting the message on the wired backbone; the second gateway node receiving the message on the wired backbone and, in response thereto, the second gateway node wirelessly transmitting the message to the selected second sub-network node.

2. The method of claim 1 wherein the message includes a distinct identifier, a subset of the second sub-network nodes comprising subscribing nodes, the subscribing nodes subscribing to the distinct identifier.

3. The method of claim 2 wherein the data routing technique is a flooding technique in which the message broadcasted on the wired backbone by the first gateway node is received by each other one of the plurality of gateway nodes and, in response thereto, each other one of the plurality of gateway nodes broadcasts the message to each of the plurality of sub-network nodes electronically coupled thereto; only the subscribing nodes accepting the message, said selected second sub-network node being a subscribing node.

4. The method of claim 2 wherein the data routing technique is a selective multicast technique in which the message broadcasted on the wired backbone by the first gateway node is received by each other one of the plurality of gateway nodes and, in response thereto, only those of the plurality of gateway nodes that are coupled to at least one of the subscribing nodes broadcast the message to the sub-network nodes coupled thereto, said selected second sub-network node being a subscribing node and, therefore, said second gateway node broadcasts the message to the selected second sub-network node coupled thereto.

5. The method of claim 1 wherein the wired backbone includes a network protocol, the protocol being one of a CAN protocol, a FlexRay protocol and an Ethernet protocol.

6. The method of claim 1 wherein the step of transmitting a message from a selected said first sub-network node to a selected said second sub-network node by using a data routing technique includes the steps of the selected first sub-network node wirelessly broadcasting the message to the first gateway node using a first frequency; and the second gateway node wirelessly broadcasting the message to the selected second sub-network node using a second frequency, the second frequency being different from the first frequency.

7. The method of claim 1 further comprising the step of electronically connecting a body computer to the wired backbone, the body computer selecting at least one frequency on which wireless communication is conducted between the gateway nodes and the sub-network nodes.

8. The method of claim 7 wherein the body computer periodically selects different frequencies on which wireless communication is conducted between the gateway nodes and the sub-network nodes.

9. A method for providing electronic communications between nodes of a vehicle, the method comprising the steps of:
electronically connecting a plurality of gateway nodes to one another via a wired backbone, including electronically connecting a first of the gateway nodes to the wired backbone and electronically connecting a second of the gateway nodes to the wired backbone;
wirelessly communicatively coupling a plurality of sub-network nodes to respective ones of the plurality of gateway nodes, including wirelessly communicatively coupling a plurality of first sub-network nodes to the first gateway node, and wirelessly communicatively coupling a plurality of second sub-network nodes to the second gateway node; and
transmitting a message including a distinct identifier, the message being transmitted from a selected said first sub-network node to a selected said second sub-network node by using a selective multicast data routing technique, at least one of the plurality of sub-network nodes being a subscribing node, the at least one subscribing node subscribing to the distinct identifier;
wherein the selective multicast data routing technique includes the steps of the selected first sub-network node wirelessly transmitting the message to the first gateway node; the first gateway node receiving the message and, in response thereto, the first gateway node broadcasting the message on the wired backbone; each other one of the plurality of gateway nodes receiving the message broadcasted on the wired backbone by the first gateway node and, in response thereto, only those of the plurality of gateway nodes that are coupled to at least one of the subscribing nodes broadcast the message to the plurality of sub-network nodes coupled thereto, said selected second sub-network node being a subscribing node.

10. The method of claim 9 wherein the wired backbone includes a network protocol, the protocol being one of a CAN protocol, a FlexRay protocol and an Ethernet protocol.

11. The method of claim 9 wherein the step of transmitting a message from a selected said first sub-network node to a selected said second sub-network node by using a selective multicast data routing technique includes the steps of the selected first sub-network node wirelessly broadcasting the message to the first gateway node using a first frequency; and the second gateway node wirelessly broadcasting the message to the selected second sub-network node using a second frequency, the second frequency being different from the first frequency.

12. The method of claim 9 further comprising the step of electronically connecting a body computer to the wired backbone, the body computer selecting one or more frequencies on which wireless communication is conducted between the gateway nodes and the sub-network nodes.

13. The method of claim 12 wherein the body computer periodically selects different frequencies on which wireless communication is conducted between the gateway nodes and the sub-network nodes.

14. A method for providing electronic communications between nodes of a vehicle, the method comprising the steps of:
electronically connecting a plurality of gateway nodes to one another via a wired backbone, including electronically connecting a first of the gateway nodes to the wired backbone and electronically connecting a second of the gateway nodes to the wired backbone;
wirelessly communicatively coupling a plurality of sub-network nodes to each of the plurality of gateway nodes, including wirelessly communicatively coupling a plurality of first sub-network nodes to the first gateway node, and wirelessly communicatively coupling a plurality of second sub-network nodes to the second gateway node; and
transmitting a message from a selected said first sub-network node to a selected said second sub-network node by using a data routing technique,
wherein the data routing technique includes the steps of the selected first sub-network node wirelessly transmitting the message to the first gateway node using a first frequency; the first gateway node receiving the message and, in response thereto, the first gateway node broadcasting the message on the wired backbone; the second gateway node receiving the message and, in response thereto, the second gateway node wirelessly transmitting the message to the selected second sub-network node using a second frequency, the second frequency being different from the first frequency.

15. The method of claim 14 wherein the message includes a distinct identifier, a subset of the second sub-network nodes comprising subscribing nodes, the subscribing nodes subscribing to the distinct identifier.

16. The method of claim 15 wherein the data routing technique employs the steps of: the first gateway node communicating the message on the wired backbone via a wired connection; each other one of the plurality of gateway nodes receiving the message on the wired backbone and, in response thereto, each other one of the plurality of gateway nodes broadcasting the message to each of the plurality of sub-network nodes electronically coupled thereto; and only the subscribing nodes accepting the message, the selected second sub-network node being a subscribing node.

17. The method of claim 15 wherein the data routing technique employs the steps of: the first gateway node communicating the message on the wired backbone via a wired connection; each other one of the plurality of gateway nodes receiving the message and, in response thereto, only those of the plurality of gateway nodes that are coupled to subscribing nodes broadcasting the message to the sub-network nodes connected thereto, said selected second sub-network node being a subscribing node and, therefore, said second gateway node broadcasts the message to the selected second sub-network node coupled thereto.

18. The method of claim 14 wherein the wired backbone includes a network protocol, the protocol being one of a CAN protocol, a FlexRay protocol and an Ethernet protocol.

19. The method of claim 14 further comprising the step of electronically connecting a body computer to the wired backbone, the body computer selecting one or more frequencies at which wireless communication is conducted between the gateway nodes and the sub-network nodes.

20. The method of claim 14 wherein the body computer periodically selects different frequencies on which wireless communication is conducted between the gateway nodes and the sub-network nodes.
